(19) United States
(12) Patent Application Publication
(10) Pub. No.: US 2009/0284514 A1
(43) Pub. Date: Nov. 19, 2009

(54) PLASMA DISPLAY APPARATUS AND ITS DRIVE CIRCUIT

(76) Inventors: Koji NAGATA, Hachioji (JP); Hiroyuki Nitta, Fujisawa (JP); Tomokatsu Kishi, Yokosuka (JP); Nobuaki Kabuto, Kunitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/464,138

(22) Filed: May 12, 2009

(30) Foreign Application Priority Data
May 16, 2008 (JP) 2008-129029

(51) Int. Cl. G09G 3/28; G09G 5/00

(52) U.S. Cl. 345/211; 345/67

(57) ABSTRACT

In a plasma display apparatus and its drive circuit, a period that capacitance Cxa formed between an address electrode and an X-discharge maintaining electrode and capacitance Cya formed between the address electrode and a Y-discharge maintaining electrode are charged is provided when the address electrode is driven so that the address electrode is set to high-impedance state during a discharge maintaining period to reduce apparent capacitance. Furthermore, the charge period is set in a power withdrawing period and thereafter the address electrode is set to high-impedance state to change final arrival potential for power withdrawal to a discharge maintaining voltage.

### INCORPORATION BY REFERENCE

The present application claims priority from Japanese application JP2008-129029 filed on May 16, 2008, the content of which is hereby incorporated by reference into this application.

### BACKGROUND OF THE INVENTION

The present invention relates to drive method and apparatus of a capacitive load such as a plasma display panel (PDP).

Flat panel display (FPD) apparatuses using PDP have the advantage of being inexpensive and being made thinner and larger and are primary products together with FPD using liquid crystal in the FPD market. Recently, the FPD apparatuses are demanded to have large picture screen, high definition and high picture quality and a demand for low power consumption thereof is also increased. The light emission mechanism of PDP utilizes ultraviolet rays generated by discharge caused by application of high voltage to filling gas in a panel, the ultraviolet rays exciting a fluorescent body to get visible rays. A drive apparatus for controlling the emission of light uses a high voltage signal having one hundred and several tens volts. Moreover, the structure of the panel has electrodes between which dielectric and gas are held and accordingly the panel is regarded as a large capacitive load. In PDP, power loss upon application of the high voltage signal to the capacitive load is one of obstacles for achieving the demanded low power consumption.

U.S. Pat. No. 4,707,692 is disclosed with the purpose of reducing power loss accompanying charge and discharge of the capacitive load. The publication shows power withdrawing means for withdrawing electric power charged in the capacitive load and using it for charge of the capacitive load again. In a concrete method thereof, another capacitance is connected to the capacitive load (C) through an inductor (L) and energy is shifted between the capacitance and the capacitive load by LC resonance, so that the electric power charged in the capacitive load is withdrawn to be reused. This technique attains the low power consumption by reusing the electric power charged to the capacitive load efficiently, although the withdrawal efficiency of electric power does not attain 100% due to a loss component (R) contained in LC resonance circuit. Accordingly, in order to further reduce the electric power using the power withdrawal method accompanied by the limited loss factor, it is necessary to reduce the capacitive load itself. However, the panel capacitance constituting the capacitive load is a characteristic decided in accordance with the panel structure for attaining efficient discharge and accordingly it is not easy to reduce the capacitive load. In contrast, JP-A-2006-58436 discloses the technique that the object thereof is different from the low power consumption but the capacitive load is controlled to be changed spuriously in accordance with conditions of a signal for driving the panel.

In the technique described in JP-A-2006-58436, the PDP includes X-discharge maintaining electrodes and Y-discharge maintaining electrodes disposed in parallel with each other and address electrodes disposed to cross them so that partial address electrodes are connected to fixed potential of 0 volt or the like and other address electrodes are not connected to the fixed potential of 0 volt or the like and are set to electrically floating state (hereinafter referred to setting to high-impedance state) during the period that discharge is performed between the X-discharge maintaining electrodes and the Y-discharge maintaining electrodes, so that peak current for maintaining discharge is reduced. The potential of the partial address electrodes set to the high-impedance state during the discharge maintaining period is equal to an intermediate value between voltages at the X- and Y-discharge maintaining electrodes due to high-impedance state. The potential at the address electrodes connected to the fixed potential of 0 volt or the like is different from that at the address electrodes set to the high-impedance state. Consequently, discharge conditions of discharge cells existing at intersection points of the X- and Y-discharge maintaining electrodes with the address electrodes are changed and discharge timing is shifted, so that the peak current for maintaining discharge is reduced. The effect of this prior-art technique is considered to be attained by setting the address electrodes to high-impedance state during the maintenance discharge to thereby change the capacitance of the panel.

### SUMMARY OF THE INVENTION

However, generally, when a power supply voltage (Va) of a control circuit for driving the address electrodes is smaller than amplitude (Vs) of a control signal for the X- and Y-discharge maintaining electrodes and the power supply voltage (Va) and the amplitude (Vs) of the control signal have the relation of Va<Vs/2, the potential at the address electrodes exceeds the voltage Va when the address electrodes are set to high-impedance state and accordingly the high-impedance state cannot be maintained. This phenomenon is not a primary factor for impeding the object of the technique of JP-A-2006-58436 but it is an important problem in the object of reducing apparent capacitance by the high impedance and attaining the low power consumption. In order to avoid it, it is necessary to heighten a resisting voltage of the drive circuit for the address electrodes and the power supply voltage Va to maintain the high-impedance state, although the increased cost of components is caused by heightening the resisting voltage of the drive circuit.

It is an object of the present invention to realize a method of attaining low power consumption of PDP at low cost by setting address electrodes to high-impedance state during discharge maintaining period to reduce apparent capacitance without heightening the resisting voltage of the drive circuit for the address electrodes.

According to the present invention, during one period that first and second different discharge maintaining potentials are applied to first electrode (for example, X-discharge maintaining electrode) and second electrode (for example, Y-discharge maintaining electrode) so that polarity of electric field between the first and second electrodes is changed alternately, a state (for example, non-high-impedance state) that third electrode (for example, address electrode) is connected to fixed potential (for example, ground potential) and a state (for example, high-impedance state) that the third electrode is not connected to the fixed potential are provided as the state of the third electrode. That is, when the address electrode is driven so that the address electrode is set to high-impedance state during a discharge maintaining period to reduce apparent capacitance, there is provided a period that capacitance Cxa formed between the address electrode and the X-discharge maintaining electrode and capacitance Cya formed between the address electrode and the Y-discharge maintaining electrode are charged. Particularly, the charge period is set in a power withdrawing period and thereafter the address electrode is set to high-impedance state to change final arrival potential for power withdrawal to a discharge maintaining voltage.

Moreover, according to the present invention, pixels are set to non-high-impedance state during a period that pixels are charged with withdrawn electric charge and pixels are set to high-impedance state at least during a period that pixels are charged with new electric charge.

Furthermore, according to the present invention, the second electrode (for example, address electrode) is connected to a fixed potential end (for example, ground end) during a period that a first drive circuit (for example, X- and Y-discharge maintaining electrode drive circuits) applies voltage to the first electrode using withdrawn electric charge and the second electrode is separated from the fixed potential end at least during a period that the first drive circuit applies voltage to the first electrode using a power supply circuit.

Moreover, according to the present invention, parasitic capacitance (for example, Cxa) formed between the first and third electrodes (for example, address electrode) and parasitic capacitance (for example, Cya) formed between the second and third electrodes are connected in series to each other at least during period that the first drive circuit (for example, X-discharge maintaining electrode drive circuit) or the second drive circuit (for example, Y-discharge maintaining electrode drive circuit) applies voltage to the first electrode (for example, X-discharge maintaining electrode) or the second electrode (for example, Y-discharge maintaining electrode) using the power supply circuit.

According to the present invention, the address electrode is set to high-impedance state at proper timing in discharge maintaining electrode driving operation, so that panel capacitance can be reduced apparently and reactive power can be reduced. Consequently, the power consumption of the plasma display apparatus can be reduced.

Furthermore, according to the present invention, change in potential at the address electrode at the time that it is set to high-impedance state can be set within the range of power supply voltage of the address electrode drive circuit and accordingly function can be realized at low cost.

The present invention is effective even in case where the relation of power supply voltage (Va) of control circuit for driving the address electrode and amplitude (Vs) of control signal for the X- and Y-discharge maintaining electrodes satisfies Va<Vs/2.

Other objects, features and advantages of the invention will become apparent from the following description of the embodiments of the invention taken in conjunction with the accompanying drawings.

### BRIEF DESCRIPTION OF THE DRAWINGS

FIGS. 1A, 1B and 1C schematically illustrate panel structure and configuration of a drive circuit;

FIGS. 2A, 2B, 2C and 2D illustrate a prior-art control method;

FIGS. 3A, 3B, 3C and 3D illustrate the prior-art control method;

FIGS. 4A, 4B, 4C and 4D illustrate a prior-art control method;

FIGS. 5A, 5B, 5C and 5D illustrate the prior-art control method;

FIGS. 6A, 6B, 6C and 6D schematically illustrate an embodiment of the present invention;

FIGS. 7A, 7B, 7C and 7D schematically illustrate the embodiment of the present invention;

FIGS. 8A, 8B, 8C and 8D schematically illustrate the embodiment of the present invention;

FIGS. 9A, 9B and 9C schematically illustrate the embodiment of the present invention;

FIGS. 10A, 10B, 10C and 10D schematically illustrate the embodiment of the present invention;

FIG. 11 illustrates the embodiment of the present invention;

FIG. 12 illustrates the embodiment of the present invention; and

FIG. 13 schematically illustrates a PDP using the control method of the embodiment 1 or 2 of the present invention.

### DESCRIPTION OF THE EMBODIMENTS

Embodiments 1 and 2 of the present invention are now described.

### Embodiment 1

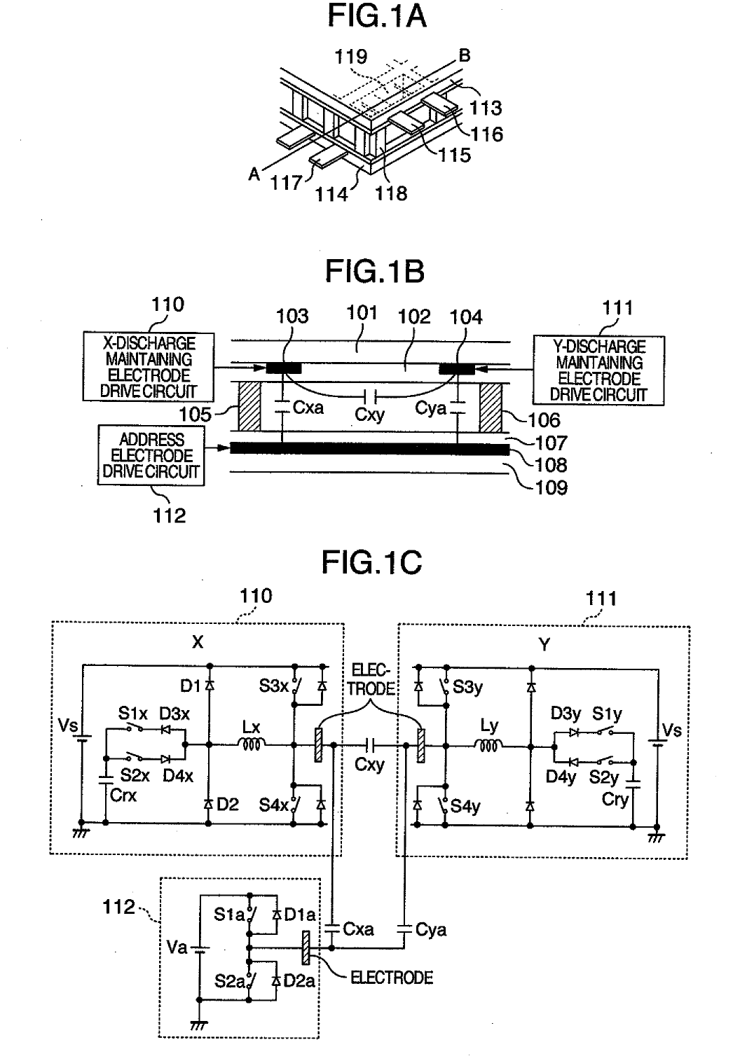

FIG. 1A illustrates the structure of a PDP (plasma display panel). The PDP includes ribs (support members) 118 formed between a front panel 113 and a back panel 114 opposite to the front panel 113. The ribs 118 are generally formed into box and individual discharge spaces 119 (discharge cells or pixels) are formed by the front panel 113, the back panel 114 and the ribs 118. X-discharge maintaining electrodes 115 and Y-discharge maintaining electrodes 116 are alternately formed in the front panel 113 in parallel with each other. Furthermore, address electrodes 117 are formed in the back panel 114 in the direction of crossing the X-discharge maintaining electrodes 115 and the Y-discharge maintaining electrodes 116.

FIG. 1B is a sectional view taken along line A-B in FIG. 1A. X-discharge maintaining electrode 103 and Y-discharge maintaining electrode 104 are formed on front panel 101 and dielectric layer 102 is formed so as to cover them. Address electrode 108 is formed on back panel 109 and dielectric layer 107 is formed so as to cover them. Ribs 105 and 106 are disposed between the front panel 101 and the back panel 109. Large parasitic capacitances exist between the electrodes due to such structure. Capacitance Cxy exists between the X- and Y-discharge maintaining electrodes 103 and 104, capacitance Cxa between the X-discharge maintaining electrode 103 and the address electrode 108 and capacitance Cya between the Y-discharge maintaining electrode 104 and the address electrode 108. The respective electrodes are connected to respective electrode drive circuits.

FIG. 1C is a diagram illustrating an equivalent circuit showing the connection relation of the parasitic capacitances and the drive circuits. In FIG. 1C, X-discharge maintaining electrode drive circuit 110 is shown as “X” and Y-discharge maintaining electrode drive circuit 111 is shown as “Y”. Furthermore, for simplification of explanation, the configuration of both circuits is made to be identical. The X- and Y-discharge maintaining electrode drive circuits 110 and 111 includes power supplies Vs therefor, switch circuits (S3x, S4x, S3y and S4y) for applying discharge maintaining voltage and power withdrawing circuits (Lx, S1x, S2x, D3x, D4x, Ly, S1y, S2y, D3y and D4y) as primary constituent elements thereof. Address electrode drive circuit 112 includes power supply Va therefor and switch circuits (S1a, S2a, D1a and D2a) as primary constituent elements thereof. Respective outputs of the drive circuits are connected to the respective electrodes and connected through parasitic capacitances between the electrodes. Potentials of the power supplies Vs and Va are different from each other.

The driving operation is now described with reference to the panel structure and the drive circuit shown in FIG. 1.

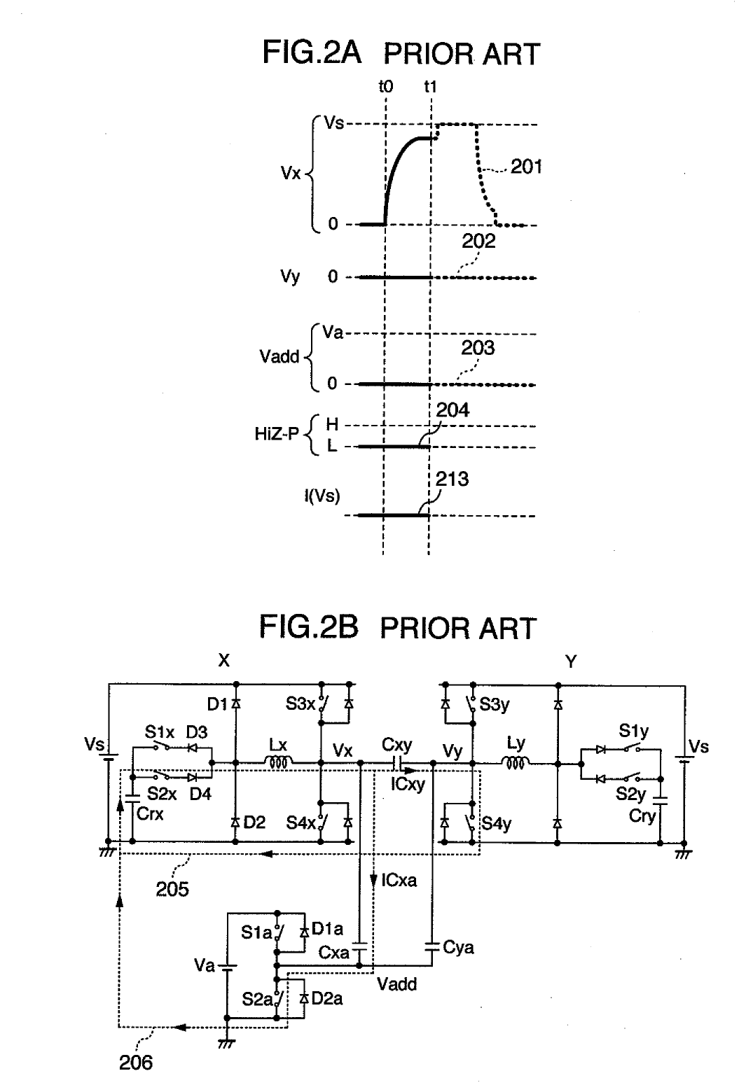

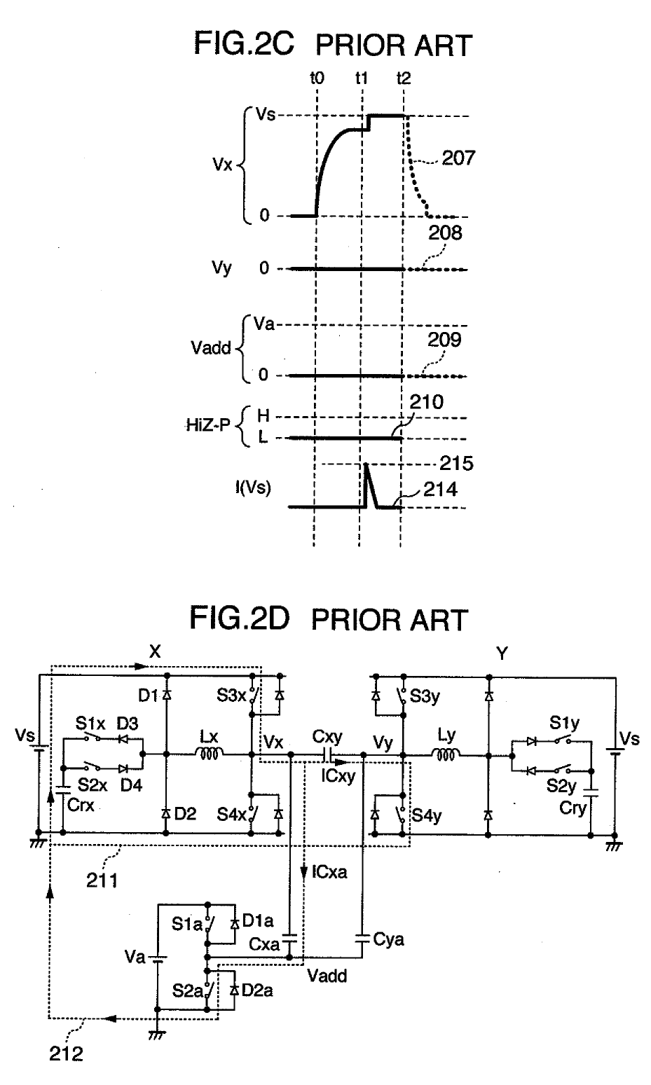

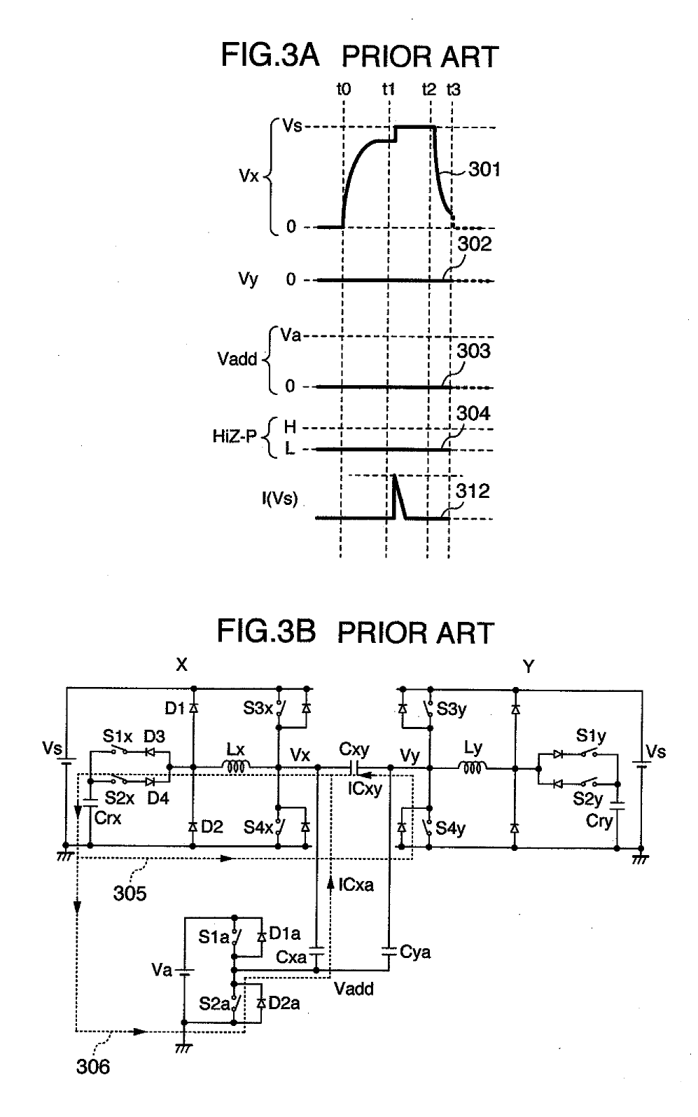

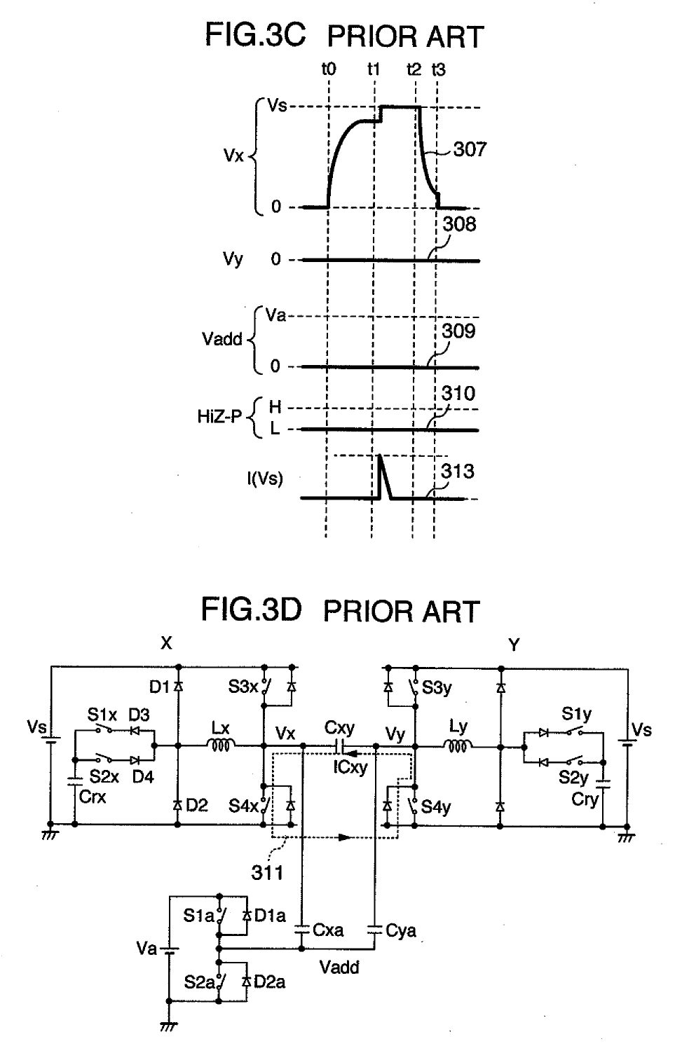

FIGS. 2A to 2D and 3A to 3D illustrate the drive method performed generally heretofore. FIG. 2A shows a waveform 201 of an application voltage Vx to the X-discharge maintaining electrode, a waveform 202 of an application voltage Vy to the Y-discharge maintaining electrode, a waveform 203 of a potential Vadd at the address electrode, a waveform 204 of a control signal HiZ-P for setting the address electrode of the address electrode drive circuit to high-impedance state and a waveform 213 of a power supply current I(Vs). In this example, since the general drive method in the prior art is illustrated, the control signal HiZ-P 204 for setting the address electrode of the address electrode drive circuit to high-impedance state is always set to be low (L) and the potential Vadd 204 at the address electrode is fixed to 0 volt.

The application voltage Vx 201 to the X-discharge maintaining electrode rises by the power withdrawing circuit from time t0 to t1. A current route at this time is shown in FIG. 2B. Currents ICxy and ICxa for charging the capacitances Cxy and Cxa, respectively, flow through current routes 205 and 206, respectively. FIG. 2C illustrates operation after time t1. After time t1, a discharge maintaining voltage Vs is applied to the X-discharge maintaining electrode (clamped to Vs). At this time, since there is difference between an arrival voltage by the power withdrawing circuit and the voltage Vs, a step occurs in a waveform 207 of the application voltage Vx to the X-discharge maintaining electrode. At this time, a power supply current I(Vs) 214 having a large peak 215 flows. FIG. 2D shows current routes at this period. The power supply current I(Vs) 214 having the peak 215 flows from the power supply Vs to the capacitances Cxy and Cxa through current routes 211 and 212. The power supply current I(Vs) 214 having the peak 215 becomes unwithdrawable current and is a primary factor for generating reactive power.

FIGS. 3A to 3D are diagrams illustrating operation after time t2 of the general prior-art drive method shown in FIGS. 2A to 2D. The waveforms of FIGS. 3A to 3D are identical with those of FIGS. 2A to 2D. FIG. 3A shows operation for the period from time t2 to time t3. This is the period that voltage Vx 301 at the X-discharge maintaining electrode falls from the discharge maintaining voltage Vs by the power withdrawing circuit. As shown in FIG. 3B, electric power charged in the capacitances Cxy and Cxa is withdrawn through current routes 305 and 306, respectively. FIG. 3C shows operation after time t3. In this period, potential Vx 307 at the X-discharge maintaining electrode is reset to 0 volt after time t3. This is a process of excreting or discharging electric power that cannot be withdrawn by power withdrawing operation. FIG. 3D shows a current route in this process. The excreted electric power is substantially equal to electric power supplied from power supply current I(Vs) 313 for the period from time t1 to t2. As described above, in the generally performed conventional method of fixing the address electrode to potential such as 0 volt or the like (not to be set to high-impedance state) at all times, electric power for charging the capacitances Cxy and Cxa (or Cya) in parallel from the potential reached by the power withdrawing operation to the discharge maintaining voltage Vs is reactive power.

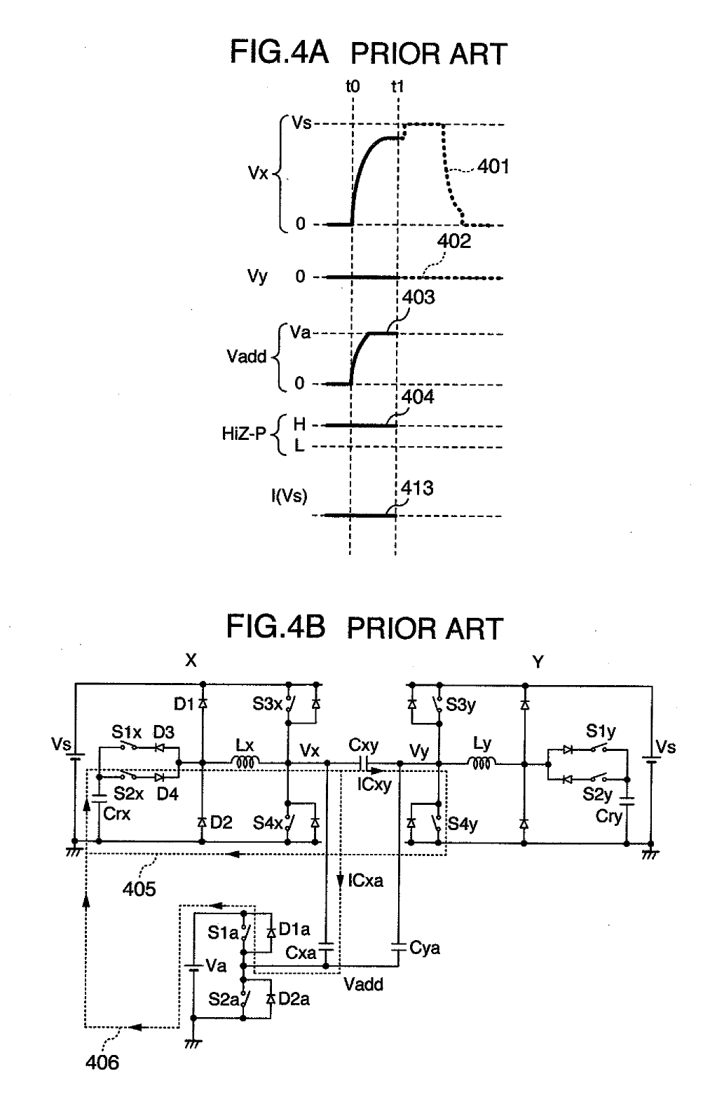

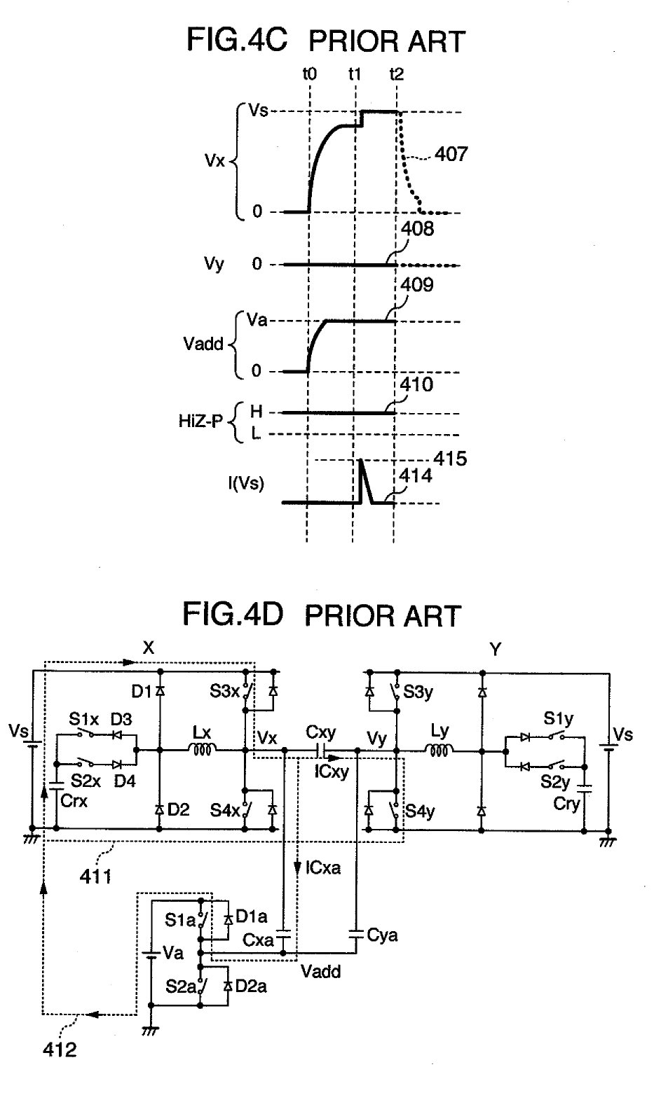

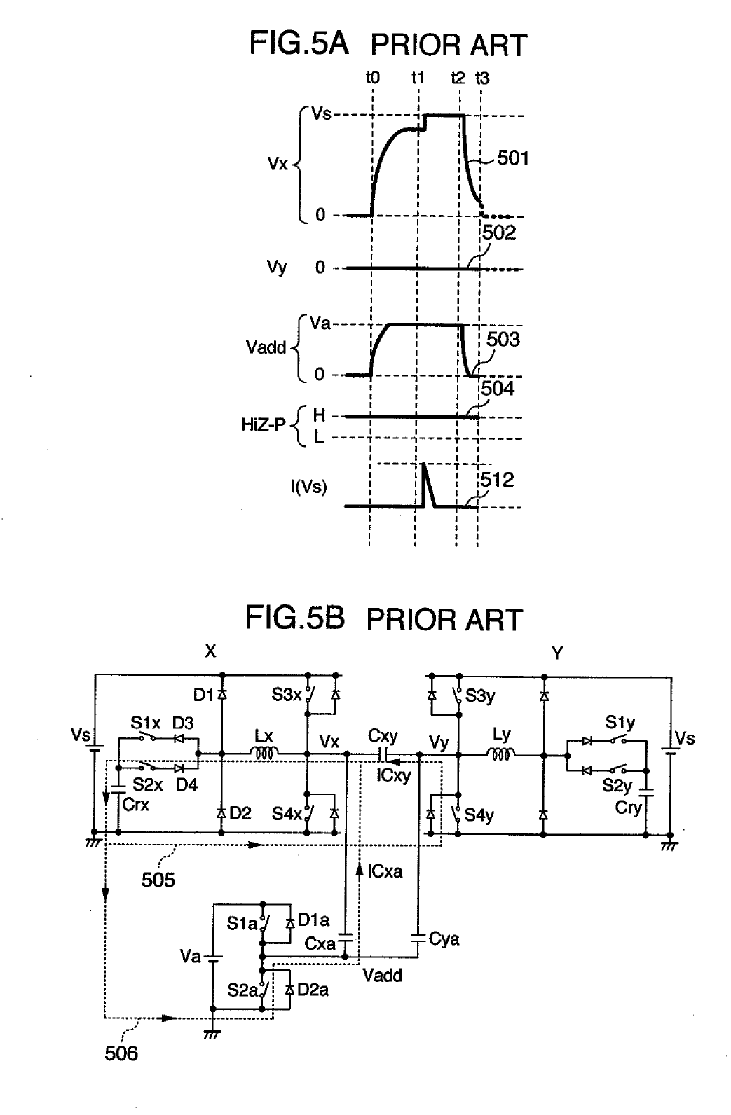

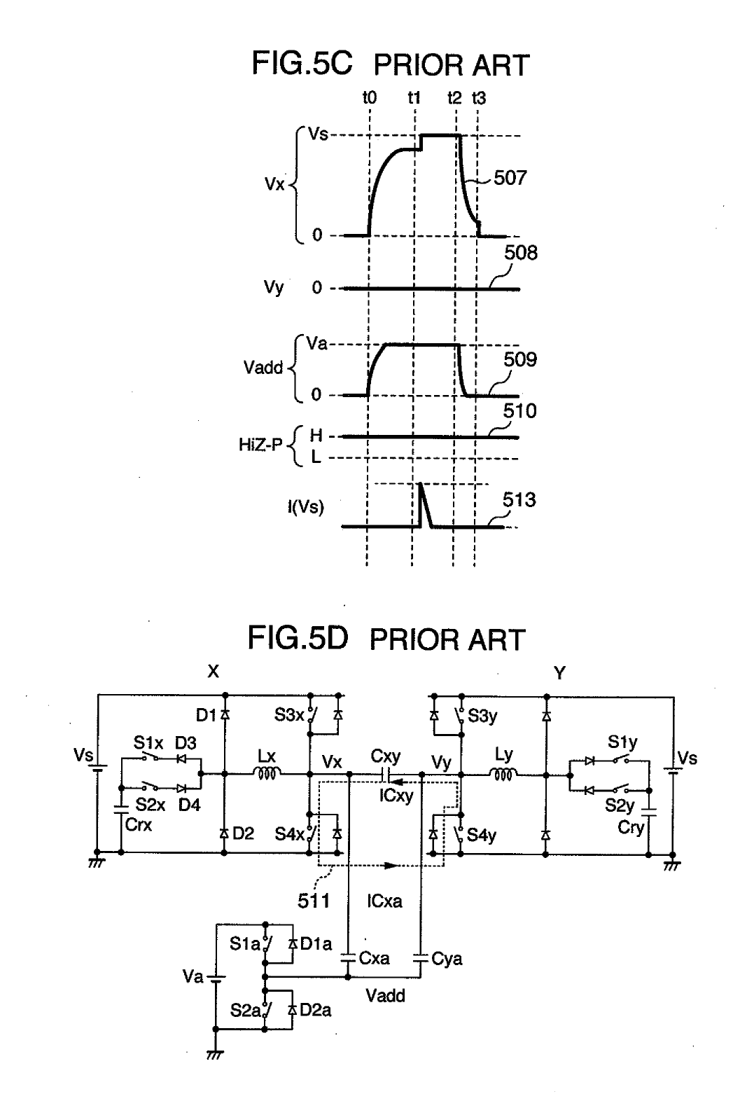

FIGS. 4A to 4D and 5A to 5D illustrate the drive method referred to as the prior art (JP-A-2006-58436). The waveforms in these drawings are identical with those of FIGS. 2A to 2D. Since this example shows the drive method referred to as the prior art, control signal HiZ-P 404 for setting the address electrode of the address electrode drive circuit to high-impedance state is always high (H) and potential Vadd 403 at the address electrode is not fixed to specified potential.

In FIG. 4A, application voltage Vx 401 at the X-discharge maintaining electrode rises by the power withdrawing circuit from time t0 to time t1. At this time, intermediate potential between the application voltage Vx 401 at the X-discharge maintaining electrode and application voltage Vy 402 at the Y-discharge maintaining electrode is applied as the potential Vadd 403 at the address electrode and gradually rises. When the intermediate potential exceeds the power supply voltage Va of the address electrode drive circuit, a diode D1a of the address electrode drive circuit shown in FIG. 4B becomes conductive and accordingly the potential Vadd 403 at the address electrode is clamped to the power supply voltage Va. Thereafter, the application voltage Vx 401 at the X-discharge maintaining electrode rises until time t1. Current routes at this time are shown in FIG. 4B. Currents ICxy and ICxa for charging the capacitances Cxy and Cxa flow through current routes 405 and 406, respectively. FIG. 4C is a diagram illustrating operation after time t1. After time t1, the discharge maintaining voltage Vs is applied to the X-discharge maintaining electrode (clamped to Vs). At this time, since there is difference between an arrival voltage by the power withdrawing circuit and the voltage Vs, a step occurs in a waveform 407 of the application voltage Vx to the X-discharge maintaining electrode. At this time, a power supply current I(Vs) 414 having a large peak 415 flows. FIG. 4D shows current routes at this period. The power supply current I(Vs) 414 having the peak 415 flows from the power supply Vs to the capacitances Cxy and Cxa through current routes 411 and 412. The power supply current I(Vs) 414 having the peak 415 becomes unwithdrawable current and is a primary factor for generating reactive power.

FIGS. 5A to 5D are diagrams illustrating operation after time t2 of the drive method referred to as the prior art shown in FIGS. 4A to 4D. The waveforms in FIGS. 5A to 5D are identical with those of FIGS. 4A to 4D. FIG. 5A shows operation for period from time t2 to time t3. This is the period that voltage Vx 501 at the X-discharge maintaining electrode falls from the discharge maintaining voltage Vs by the power withdrawing circuit. As shown in FIG. 5B, electric power charged in the capacitances Cxy and Cxa is withdrawn through current routes 505 and 506, respectively. FIG. 5C shows operation after time t3. In this period, potential Vx 507 at the X-discharge maintaining electrode is reset to 0 volt after time t3. This is a process of excreting or discharging electric power that cannot be withdrawn by power withdrawing operation. FIG. 5D shows a current route in this process. This excreted electric power is equal to electric power supplied by power supply current I(Vs) 513 for the period from time t1 to t2. As described above, in the drive method referred to as the prior art, that is, in the method of setting the address electrode to high-impedance state (not to be fixed to specified potential) at all times, electric power for charging the capacitances Cxy and Cxa (or Cya) in parallel from the potential reached by the power withdrawing operation to the discharge maintaining voltage Vs is reactive power. The reactive power generated here is substantially equal to that of the method described in FIGS. 2 and 3 in which the address electrode is not set to high-impedance state. Accordingly, in the method in which the address electrode is always set to high-impedance state, the reactive power cannot be reduced.

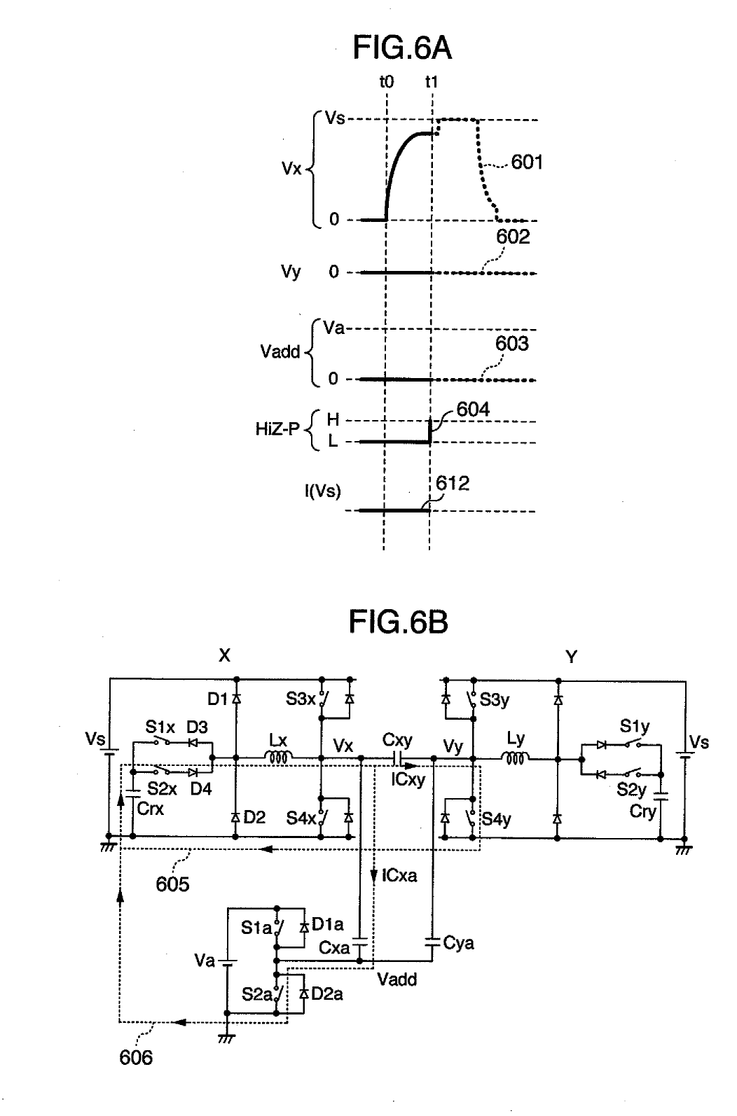

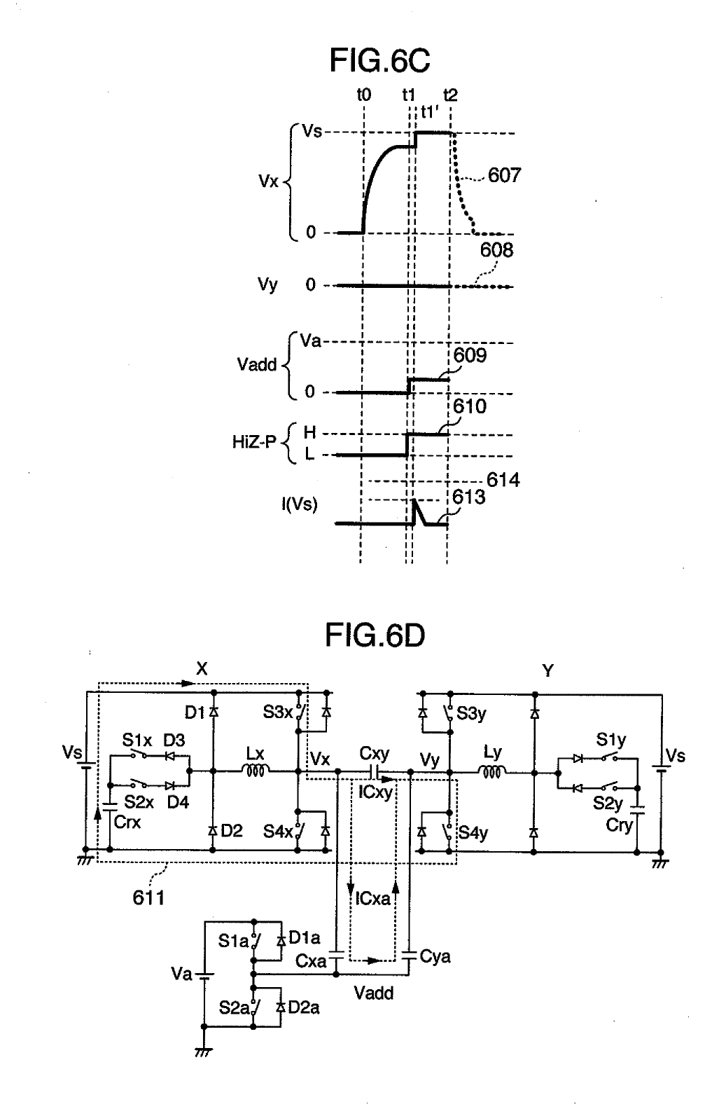

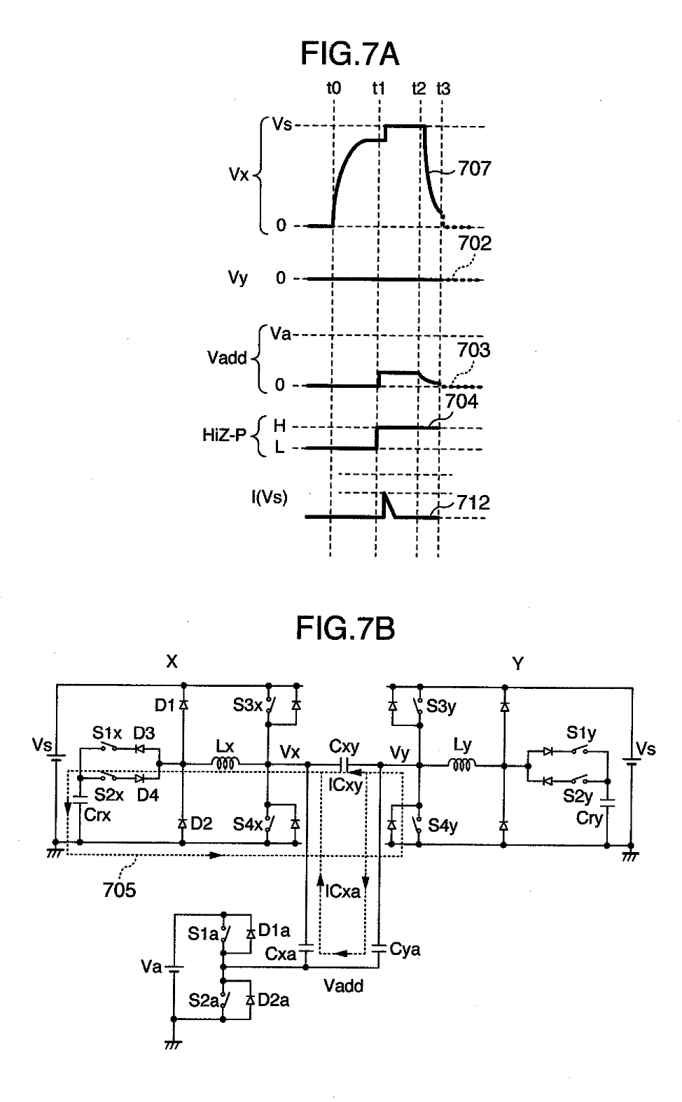

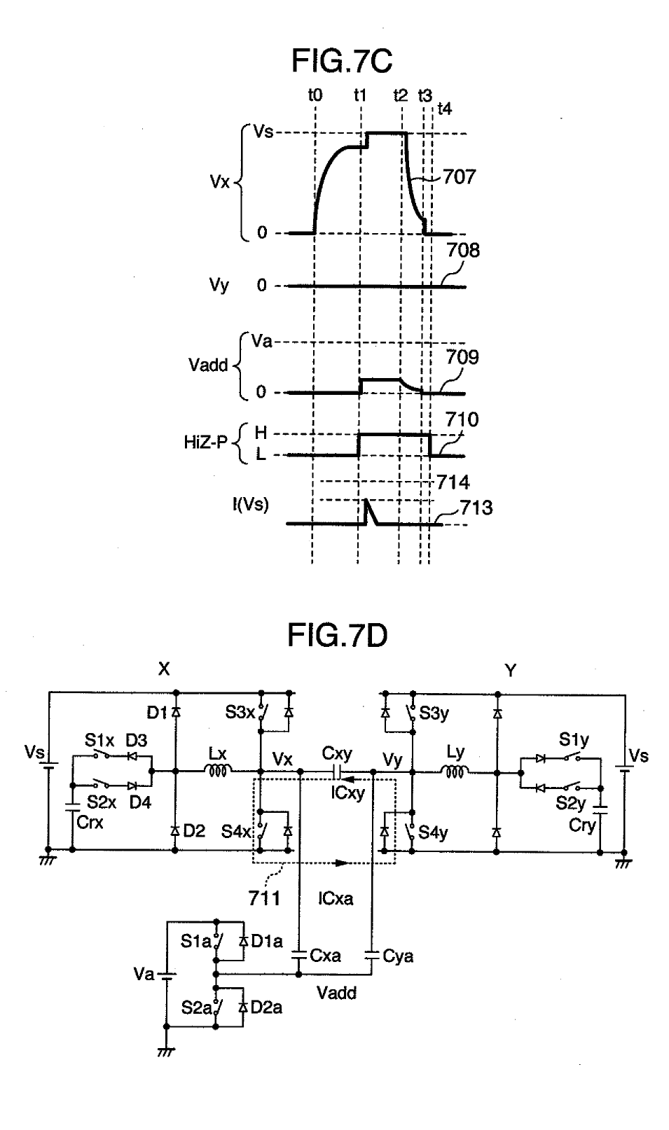

FIGS. 6A to 6D and 7A to 7D schematically illustrate the drive method according to the present invention. The waveforms in these drawings are identical with those of FIGS. 2A to 2D. In this example, in order to reduce the reactive power, control signal HiZ-P 604 for setting the address electrode of the address electrode drive circuit to high-impedance state is controlled properly.

Electric power (electric charge) withdrawn by the power withdrawing circuit from time t0 to time t1 is utilized to increase application voltage Vx 601 to the X-discharge maintaining electrode. That is, the withdrawn electric charge is utilized to recharge pixels. At this time, control signal HiZ-P 604 for setting the address electrode of the address electrode drive circuit to high-impedance state is low (L). That is, the address electrode is connected to the ground (fixed potential of 0 volt) to be set to non-high-impedance state (non-floating state). Accordingly, potential Vadd 603 at the address electrode is fixed to 0 volt. Current routes at this time are shown in FIG. 6B. Currents ICxy and ICxa for charging the capacitances Cxy and Cxa flow through current routes 605 and 606, respectively. The X-discharge maintaining electrode drive circuit 110 closes switches S1x and S2x and opens switches S3x and S4x. The Y-discharge maintaining electrode drive circuit 111 opens switches S1y, S2y and S3y and closes switch S4y. The address electrode drive circuit 112 opens switch S1a and closes switch S2a. FIG. 6C shows operation after time t1. At time t1, control signal HiZ-P 610 for setting the address electrode of the address electrode drive circuit to high-impedance state is changed from low (L) to high (H). That is, the address electrode is separated from the ground and is changed from non-high-impedance state (non-floating state) to high-impedance state (floating state). Then, after time t1, the power supply Va is used to apply the discharge maintaining voltage Vs to the X-discharge maintaining electrode (clamped to Vs). That is, pixels are charged with new electric charge which is not withdrawn electric charge. At this time, since there is difference between the arrival voltage by the power withdrawing circuit and the voltage Vs, a step occurs in a waveform 607 of the application voltage Vx to the X-discharge maintaining electrode. At this time, power supply current I(Vs) 613 having a peak 614 flows. FIG. 6D shows current routes at this period. The X-discharge maintaining electrode drive circuit 110 opens switches S1x, S2x and S4x and closes switch S3x. The Y-discharge maintaining electrode drive circuit 111 opens switches S1y, S2y and S3y and closes switch S4y. The address electrode drive circuit 112 opens switches S1a and S2a. When the switch S2a is opened, the address electrode is separated from the ground (fixed potential of 0 volt) and is set to high-impedance state. The power supply current I(Vs) 613 having the peak 614 flows from the power supply Vs to the capacitance Cxy through current route 611 and at the same time flows from the power supply Vs to capacitances Cxa and Cya connected in series to each other through the current route 611. The power supply current I(Vs) 613 having the peak 614 becomes unwithdrawable current and is a primary factor for reactive power. However, the power supply current I(Vs) 613 in this example is reduced by a value contributed by the series connection of the capacitances Cxa and Cya as compared with the power supply current in the general prior-art method and the method of the prior-art technique (JP-A-2006-58436). Generally, since the capacitances Cxa and Cya are substantially equal to each other, this reduction is equivalent to reduction of capacitance between the discharge maintaining electrode and the address electrode by half. Furthermore, as shown in FIG. 6C, the rising of voltage Vadd 609 at the address electrode during the period that the address electrode is set to high-impedance state is suppressed to half of difference between the arrival voltage by the power withdrawing circuit and the voltage Vs since the capacitance Cxa is charged until time t1. After the X-discharge maintaining electrode is clamped to the discharge maintaining voltage Vs, the pixels emit light.

FIGS. 7A to 7D are diagrams illustrating operation after time t2 of the drive method according to the present invention shown in FIG. 6. The waveforms in FIGS. 7A to 7D are identical with those of FIGS. 6A to 6D. FIG. 7A shows operation for the period from time t2 to time t3. This is the period that voltage Vx 701 at the X-discharge maintaining electrode falls from the discharge maintaining voltage Vs by the power withdrawing circuit. Even in this period, control signal HiZ-P 704 for setting the address electrode of the address electrode drive circuit to high-impedance state is high (H). As shown in FIG. 7B, electric power charged in the capacitances Cxy, Cxa and Cya is withdrawn through current route 705. FIG. 7C shows operation after time t3. The X-discharge maintaining electrode drive circuit 110 closes switches S1x and S2x and opens switches S3x and S4x. The Y-discharge maintaining electrode drive circuit 111 opens switches S1y to S4y. The address electrode drive circuit 112 opens S1a and S2a. In this period, the address electrode is connected to the ground and potential Vs 707 at the X-discharge maintaining electrode is reset to 0 volt at time t3. However, the reset voltage is not limited to 0 volt. Thereafter, control signal HiZ-P 710 for setting the address electrode of the address electrode drive circuit to high-impedance state is changed from high (H) to low (L) and potential 709 at the address electrode is fixed to 0 volt. This is a process of excreting electric power that cannot be withdrawn by power withdrawing operation. FIG. 7D shows current route in the process. The X-discharge maintaining electrode drive circuit 110 opens switches S1x, S2x and S3x and closes S4x. The Y-discharge maintaining electrode drive circuit 111 opens switches S1y to S4y. The address electrode drive circuit 112 opens switches S1a and S2a. The electric power excreted or discharged here is substantially equal to electric power supplied by power supply current I(Vs) 713 for the period from time t1 to time t2. However, as described above, in the embodiment of the present invention, the timing that the address electrode is set to high-impedance state is properly controlled to reduce the apparent capacitance and accordingly the reactive power can be reduced. Moreover, when the address electrode is set to high-impedance state, change in potential at the address electrode can be suppressed within the range of power supply voltage of the address electrode drive circuit.

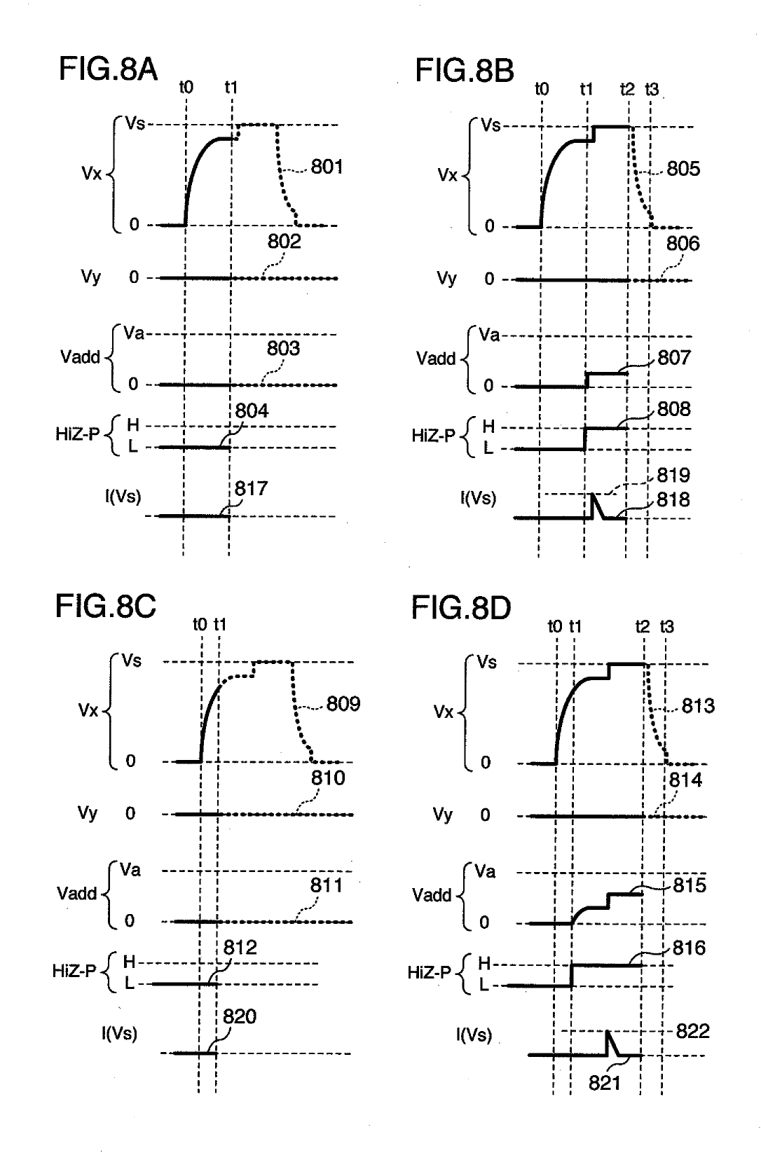

FIGS. 8A to 8D are diagrams illustrating the relation of the start timing that the address electrode is set to high-impedance state and the change in potential at the address electrode during the period that the address electrode is set to high-impedance state. The waveforms in FIGS. 8A to 8D are identical with those of FIGS. 2A to 2D and the like. In FIGS. 8A and 8B, at the same timing as the examples explained in connection with FIGS. 6A to 6D and 7A to 7D, that is, just before the clamping operation to the discharge maintaining voltage Vs from the arrival voltage by the power withdrawing circuit, control signal HiZ-P 804 for setting the address electrode of the address electrode drive circuit to high-impedance state is changed from low (L) to high (H). When potential Vx 801 at the X-discharge maintaining electrode at time (t1) that the address electrode is set to high-impedance state is defined to Vx(t1), the charged voltage of the capacitance Cxa is Vx(t1). Thereafter, the address electrode is set to high-impedance state and potential Vx 801 at the X-discharge maintaining electrode is changed to Vs by clamping operation to the discharge maintaining voltage Vs. Potential Vadd 807 generated at the address electrode at this time is given by the following expression (1):

Vadd=(Vx−Vx(t1))Cxa/(Cxa+Cya) (1)

In the general PDP, since the capacitances Cxa and Cya are substantially equal to each other, the potential Vadd 807 generated at the address electrode is approximated by the following expression (2):

Vadd=(Vx−Vx(t1))/2 (2)

The maximum arrival potential at the address electrode is calculated by the following expression (3) by substituting Vs for Vx (Vx=Vs) in the expression (2).

Vadd_max=(Vs−Vx(t1))/2 (3)

FIGS. 8C and 8D illustrate operation at time earlier than the above example, that is, operation in case where difference between the time that clamping operation to the discharge maintaining voltage Vs from the arrival voltage by the power withdrawing circuit is performed and the time (t1) that the address electrode is set to high-impedance state is larger than the above example. In this example, the potential 809 at the X-discharge maintaining electrode at time t1 is Vx(t1) and is lower than that of the above example. Accordingly, the charged voltage of the capacitance Cxa is lower than that of the above example. Since the address electrode is set to high-impedance state after time t1, the potential 814 at the address electrode rises in accordance with the expression (2). When the clamping operation to the discharge maintaining voltage Vs is performed, the potential Vadd 814 at the address electrode reaches the maximum arrival potential Vadd_max shown by the expression (3). Current generated by the clamping operation to the discharge maintaining voltage Vs is changed depending on each of the following conditions for the maximum arrival potential Vadd_max for the potential Vadd at the address electrode.

Vadd_max≦Va (Condition 1)

In case of this condition, since the potential Vadd at the address electrode does not exceed the power supply voltage Va of the address electrode drive circuit during the period that the address electrode is set to high-impedance state, the power supply current I(Vs) generated by the clamping operation to the discharge maintaining voltage Vs is reduced and the reactive power is reduced.

Vadd_max>Va (Condition 2)

In case of the this condition, since the potential Vadd at the address electrode exceeds the power supply voltage Va of the address electrode drive circuit during the period that the address electrode is set to high-impedance state, the power supply current I(Vs) generated by the clamping operation to the discharge maintaining voltage Vs is not reduced. Accordingly, the reactive power is not reduced.

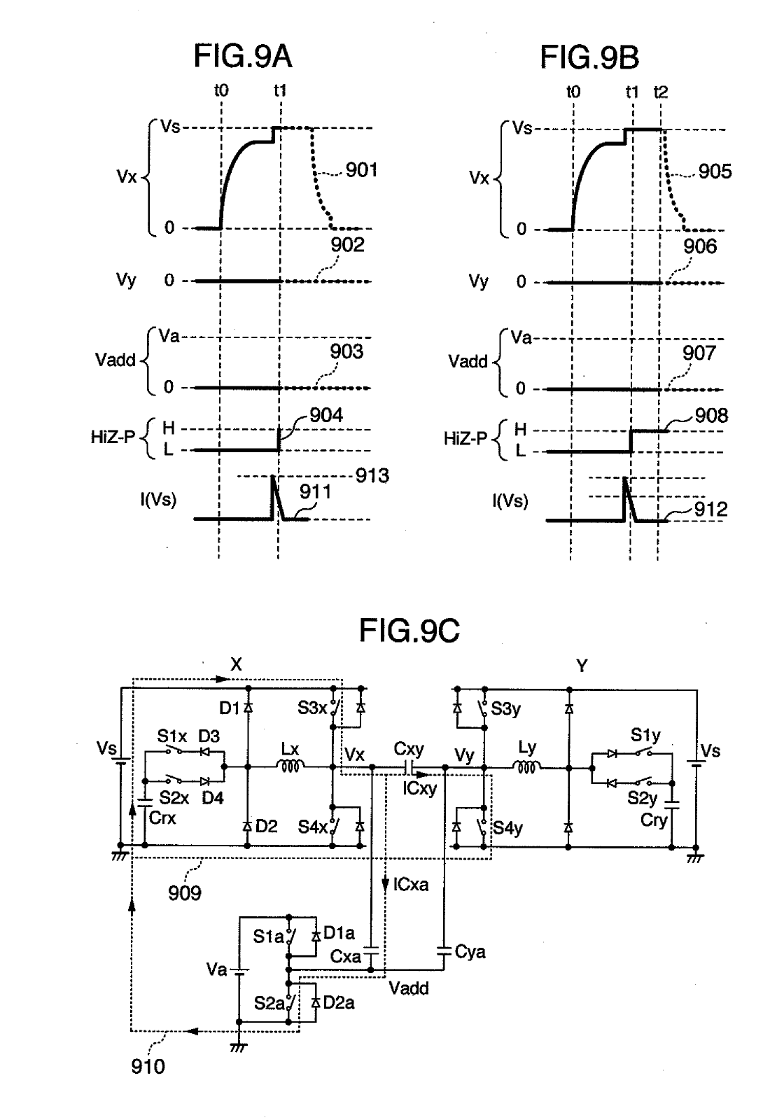

FIGS. 9A to 9C illustrate operation in case where time t1 that the address electrode is set to high-impedance is later than the clamping operation to the discharge maintaining voltage Vs from the arrival voltage by the power withdrawing circuit. The waveforms in FIGS. 9A and 9B are identical with those of FIGS. 2A and 2C. FIG. 9A illustrates operation unit time t1 that the address electrode is set to high-impedance state. Potential 901 at the X-discharge maintaining electrode rises by the power withdrawing circuit from time t0. When the potential 901 at the X-discharge maintaining electrode rises by the power withdrawing circuit and reaches the maximum point or voltage, the clamping operation to the discharge maintaining voltage Vs is performed, so that the potential 901 at the X-discharge maintaining electrode is clamped to the discharge maintaining voltage Vs. At this time, since there is difference between the arrival voltage by the power withdrawing circuit and the discharge maintaining voltage Vs, current 911 having peak 913 is generated as the power supply current I(Vs). FIG. 9C shows current routes of the power supply current I(Vs) 911. The X-discharge maintaining electrode drive circuit 110 opens switches S1x, S2x and S4x and closes switch S3x. The Y-discharge maintaining electrode drive circuit 111 opens switches S1y to S3y and closes S4y. The address electrode drive circuit 112 closes switches S1a and S2a. Thereafter, control signal HiZ-P 904 for setting the address electrode of the address electrode drive circuit to high-impedance state is changed from low (L) to high (H) at time t1. FIG. 9B illustrates operation after time t1. Since the capacitance Cxa has been already charged to the discharge maintaining voltage Vs before time t1, the potential Vadd 907 at the address electrode is maintained to 0 volt even after time t1. In case of this example, since the power supply current I(Vs) is generated before time t1 that the address electrode is set to high-impedance state, the power supply current I(Vs) is not reduced. Accordingly, the reactive power is not reduced.

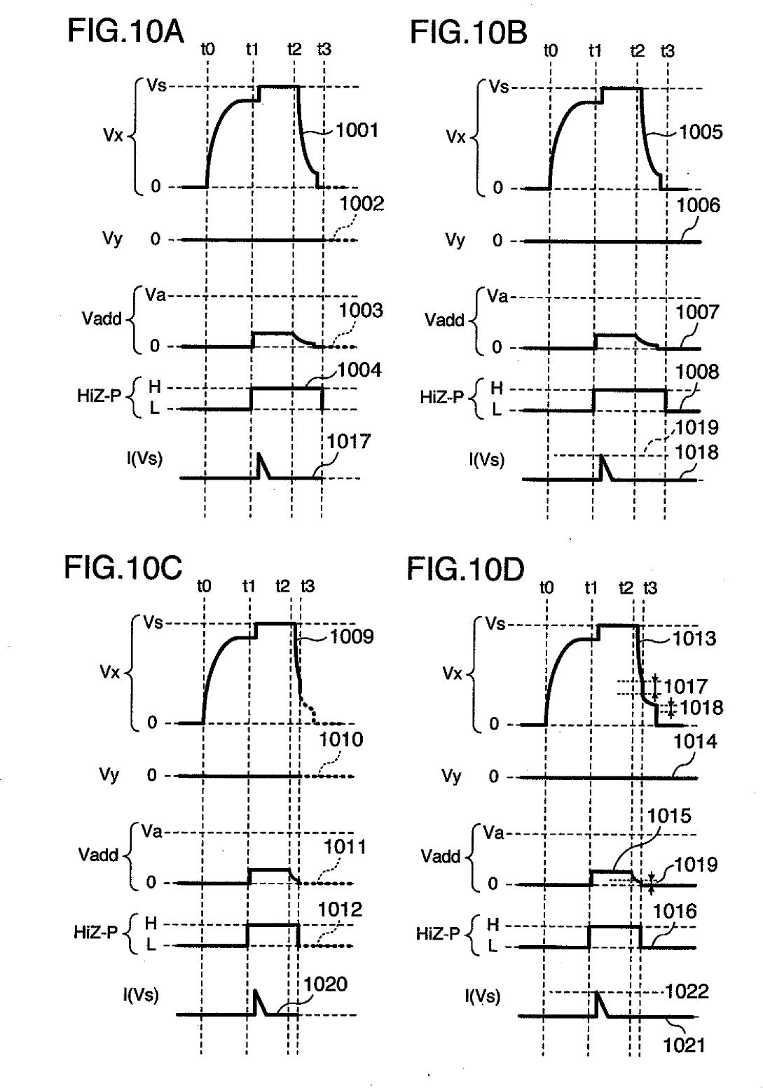

FIGS. 10A to 10D show timing that the address electrode is fixed from the high-impedance state to the potential such as 0 volt or the like. The waveforms in FIGS. 10A to 10D are identical with those of FIGS. 2A and 2C. FIG. 10A illustrates operation in case where time t3 that the address electrode is fixed from the high-impedance state to the potential such as 0 volt or the like is later than time that the potential at the discharge maintaining electrode is lowered by power withdrawing operation and is then clamped to fixed potential, in this example 0 volt. Potential Vx 1001 at the X-discharge maintaining electrode falls by function of the power withdrawing circuit from time t2 and reaches minimum arrival potential by power withdrawing operation. Thereafter, the potential is clamped to the fixed potential, in this example 0 volt. During this period, even potential Vadd 1003 at the address electrode falls similarly and reaches about 0 volt. Thereafter, at time t3, the control signal HiZ-P 1004 for setting the address electrode of the address electrode drive circuit to high-impedance state is changed from high(H) to low (L). FIG. 10B illustrates operation after time t3. In case of this condition, since the power withdrawing operation from the capacitances Cxy, Cxa and Cya is performed properly, the power withdrawal efficiency is not reduced.

FIGS. 10C and 10D illustrate operation in case where time t3 that the address electrode is fixed from the high-impedance state to the potential such as 0 volt or the like is earlier than time that the potential at the discharge maintaining electrode is lowered by power withdrawing operation and is then clamped to fixed potential, in this example 0 volt. Potential Vx 1009 at the X-discharge maintaining electrode begins to fall from time t2 of FIG. 10C. At the same time, potential Vadd 1011 at the address electrode also falls. Thereafter, at time t3, control signal HiZ-P 1012 for setting the address electrode of the address electrode drive circuit to high-impedance state is changed from high (H) to low (L). Consequently, the potential Vadd 1011 at the address electrode is clamped to 0 volt, so that electric power held at this time is excreted or discharged. The potential Vx 1009 at the X-discharge maintaining electrode is also changed discontinuously in response thereto and step or difference 1017 occurs as shown by waveform Vx 1013 at the X-discharge maintaining electrode in FIG. 10D. Consequently, the minimum arrival potential by the power withdrawing operation is high as shown by potential difference 1018 of the waveform Vx 1013 at X-discharge maintaining electrode in FIG. 10D. This exhibits reduction in the power withdrawal efficiency.

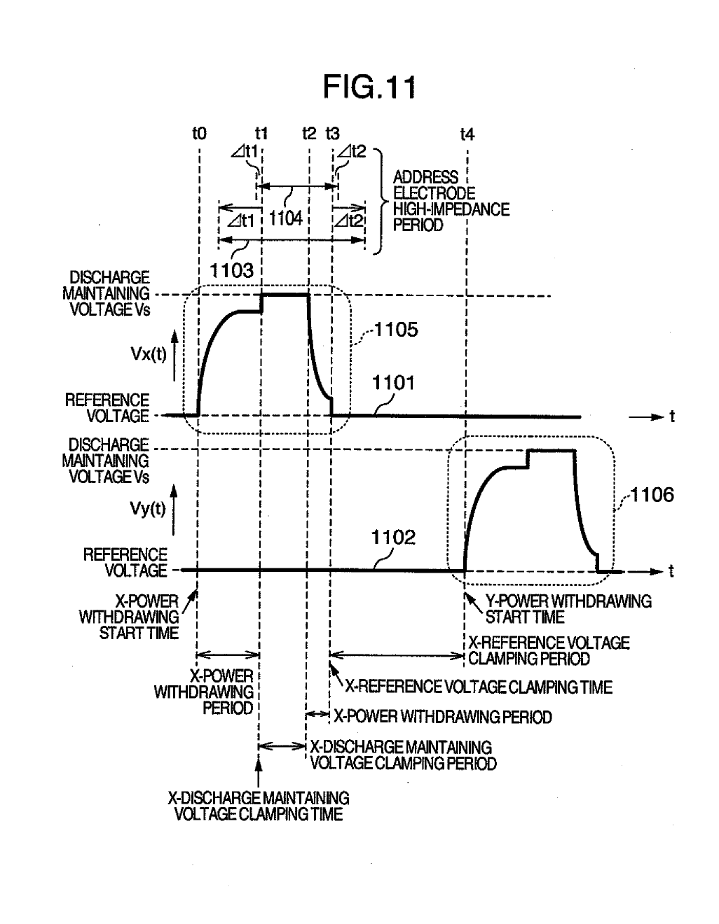

As described above, in the drive method according the present invention of setting the address electrode to high-impedance state during the specified period, there exist optimum temporal conditions for getting effects from viewpoints of compatibility of reduction in reactive power and condition of resisting voltage. The optimum conditions are now described with reference to FIG. 11.

The optimum conditions are as follows: (1) there are power reduction effects, (2) the power withdrawal efficiency is not reduced and (3) the resisting voltage condition of the address electrode drive circuit is satisfied. The period for setting the address electrode to high-impedance state in order to satisfy the above conditions is prescribed by clamping time (t1) of X-discharge maintaining voltage, clamping time (t3) of X-reference voltage, start time (t4) of Y-power withdrawing operation and time differences Δt1 and Δt2 as shown in FIG. 11. The time difference Δt1 is difference between the time t1 and the start time of the period that the address electrode is set to high-impedance state and the time difference Δt2 is difference between the time t3 and the end time of the period that the address electrode is set to high-impedance state.

First, the time difference Δt1 is prescribed. Voltage 1101 at the X-discharge maintaining electrode at time t1−Δt1 is defined to Vx(t1−Δt1). The case where the voltage Vx(t1−Δt1) satisfies conditions defined by the following expressions (4) and (5) is the optimum condition for Δt1.

2*(Vs−Vx(t1−Δt1))≦Power Supply Voltage (Va) of Address Electrode Drive Circuit (4)

Δt1>0 (5)

Next, the time difference Δt2 is prescribed. The case where the following expression (6) is satisfied is the optimum condition for Δt2.

t3≦−(t3+Δt2)<t4 (6)

The time differences Δt1 and Δt2 are set within the range that the conditions described above are satisfied, so that the optimum conditions of the drive method according to the present invention can be gotten.

Furthermore, in the foregoing description, X-discharge maintaining voltage signal 1105 has been described representatively, although the same conditions are satisfied even in case of Y-discharge maintaining voltage signal 1106 by substituting Y for X in the above description.

### Embodiment 2

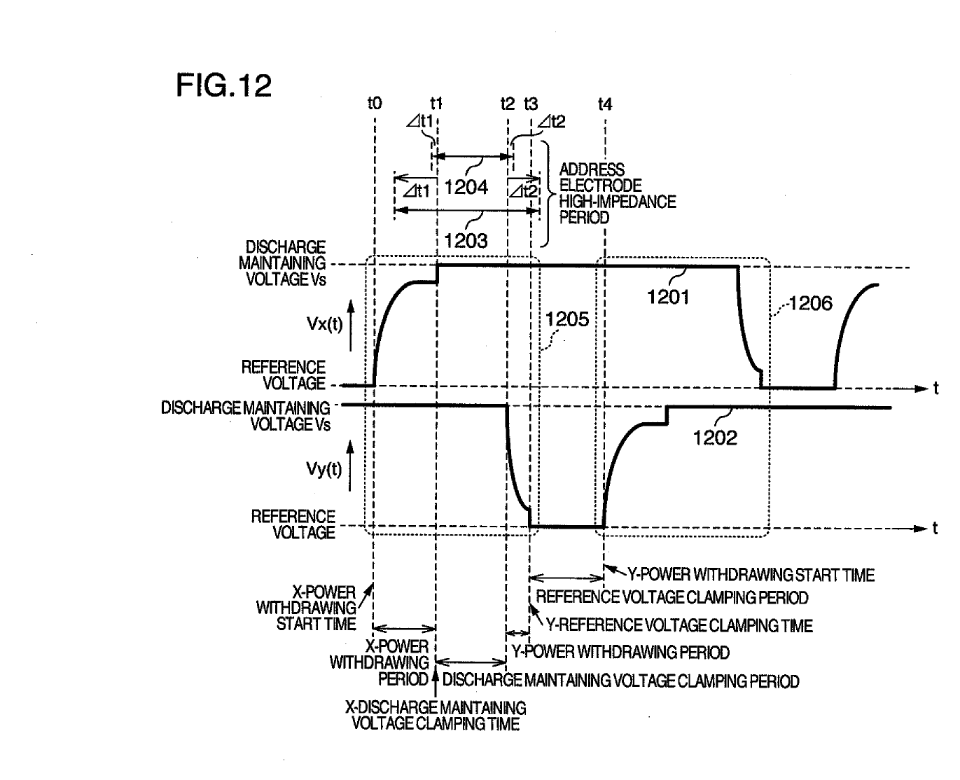

FIG. 12 is a diagram illustrating the optimum conditions in case where the present invention is applied to the case where the X-discharge maintaining electrode voltage and the Y-discharge maintaining electrode voltage are operated or applied in a combination different from the embodiment 1. In this example, the X-discharge maintaining electrode voltage 1201 and the Y-discharge maintaining electrode voltage 1202 rise and fall alternately. In this example, pairs 1205 and 1207 of rising and falling of waveforms are treated as the unit. The pair 1205 of rising and falling is described representatively. Prescriptions are made using X-discharge maintaining voltage clamping time t1, Y-reference voltage clamping time t3, Y-power withdrawing operation start time t4 and time differences Δt1 and Δt2.

First, the time difference Δt1 is prescribed. Voltage 1202 at the X-discharge maintaining electrode at time t1−Δt1 is defined to be Vx(t1−Δt1). The case where the voltage Vx(t1−Δt1) satisfies the conditions defined by the following expressions (7) and (8) is the optimum condition for the time difference Δt1.

2*(Vs−Vx(t1−Δt1))≦Power Supply Voltage (Va) of Address Electrode Drive Circuit (7)

Δt1>0 (8)

Next, the time difference Δt2 is prescribed. The case where the following expression (6) is satisfied is the optimum condition for the time difference Δt2.

t3≦(t3+Δt2)<t4 (9)

The time differences Δt1 and Δt2 are set within the range that the conditions described above are satisfied, so that the optimum conditions of the drive method according to the present invention can be gotten. In the foregoing description, the pair 1205 of rising and falling has been described representatively, although the same conditions are satisfied even in case of the pair 1206 of rising and falling in reverse.

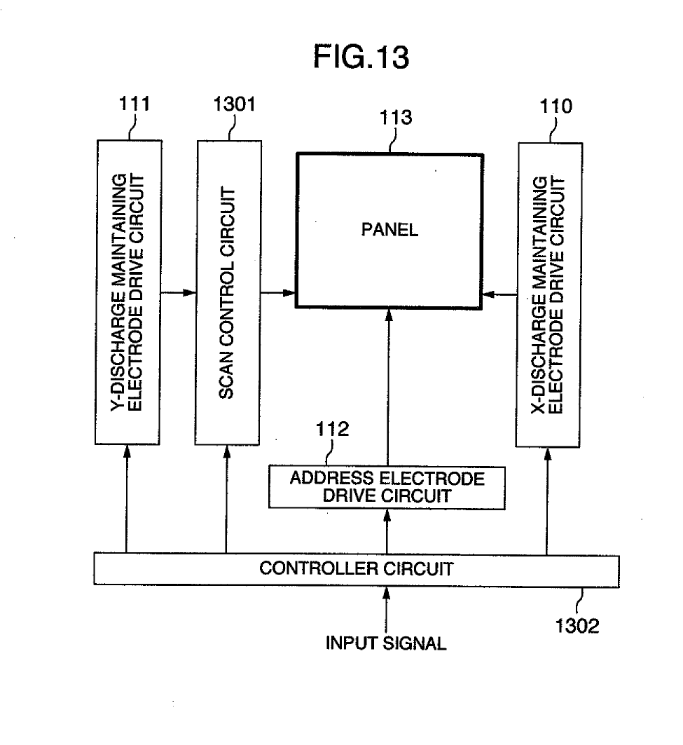

FIG. 13 is a block diagram schematically illustrating PDP using the control method of the embodiment 1 or 2 according to the present invention. A controller circuit is a functional part for controlling discharge maintaining electrode drive and address electrode drive and the control method of the present invention is effectuated by control of the controller.

The present invention can be utilized for the plasma display apparatus.

It should be further understood by those skilled in the art that although the foregoing description has been made on embodiments of the invention, the invention is not limited thereto and various changes and modifications may be made without departing from the spirit of the invention and the scope of the appended claims.

1. A plasma display apparatus including a display panel having first and second electrodes disposed alternately and a third electrode disposed opposite to the first and second electrodes, wherein
a state that the third electrode is connected to fixed potential and a state that the third electrode is not connected to the fixed potential are provided as the state of the third electrode during one period that first and second discharge maintaining potentials having different values are applied to the first and second electrodes so that polarity of electric field between the first and second electrodes is changed alternately.

2. A plasma display apparatus according to claim 1, wherein
timing that the state of the third electrode is changed from the state that the third electrode is connected to the fixed potential to the state that the third electrode is not connected to the fixed potential is set after control for increasing potential at the first or second electrode from a state that the potential at the first or second electrode is lower potential of the first and second discharge maintaining potentials is started and before higher discharge maintaining potential of the first and second discharge maintaining potentials is applied to the first or second electrode.

3. A plasma display apparatus according to claim 2, wherein
timing that the state of the third electrode is changed from the state that the third electrode is not connected to the fixed potential to the state that the third electrode is connected to the fixed potential is set after potential at the first or second electrode falls from the state that the potential at the first or second electrode is higher potential of the first and second discharge maintaining potentials and before lower discharge maintaining potential of the first and second discharge maintaining potentials is applied to the first or second electrode.

4. A plasma display apparatus according to claim 3, wherein
the timing t1 that the state of the third electrode is changed from the state that the third electrode is connected to the fixed potential to the state that the third electrode is not connected to the fixed potential, the timing t2 that control for increasing the potential at the first or second electrode from the state that the potential at the first or second electrode is lower potential of the first and second discharge maintaining potentials is started, the timing t3 that higher discharge maintaining potential of the first and second discharge maintaining potentials is applied to the first or second electrode, potential V(t1) at the first or second electrode at the timing t1, higher potential Vs of the first and second discharge maintaining potentials and the power supply voltage Va of the drive circuit for driving the third electrode satisfy the following relation:
Va>2(Vs−V(t1))
and
t1≠t3.

5. A plasma display apparatus according to claim 4, wherein
the timing t1 that the state of the third electrode is changed from the state that the third electrode is not connected to the fixed potential to the state that the third electrode is connected to the fixed potential, the timing t2 that the potential at the first or second electrode falls from the state that the potential at the first or second electrode is higher potential of the first and second discharge maintaining potentials and lower discharge maintaining potential of the first and second discharge maintaining potentials is applied to the first or second electrode, and the timing t3 that control for increasing the potential at the first or second electrode from the state that the potential at the first or second electrode is lower potential of the first and second discharge maintaining potentials is started satisfy the following relation:
t2≦t1<t3.

6. A drive circuit to drive a display panel including first and second electrodes disposed alternately and a third electrode disposed opposite to the first and second electrodes, wherein
a state that the third electrode is connected to fixed potential and a state that the third electrode is not connected to the fixed potential are provided as the state of the third electrode during one period that first and second discharge maintaining potentials having different values are applied to the first and second electrodes so that polarity of electric field between the first and second electrodes is changed alternately.

7. A drive circuit according to claim 6, wherein
timing that the state of the third electrode is changed from the state that the third electrode is connected to the fixed potential to the state that the third electrode is not connected to the fixed potential is set after control for increasing potential at the first or second electrode from a state that the potential at the first or second electrode is lower potential of the first and second discharge maintaining potentials is started and before higher discharge maintaining potential of the first and second discharge maintaining potentials is applied to the first or second electrode.

8. A drive circuit according to claim 7, wherein
timing that the state of the third electrode is changed from the state that the third electrode is not connected to the fixed potential to the state that the third electrode is connected to the fixed potential is set after potential at the first or second electrode falls from the state that the potential at the first or second electrode is higher potential of the first and second discharge maintaining potentials and before lower discharge maintaining potential of the first and second discharge maintaining potentials is applied to the first or second electrode.

9. A drive circuit according to claim 8, wherein
the timing t1 that the state of the third electrode is changed from the state that the third electrode is connected to the fixed potential to the state that the third electrode is not connected to the fixed potential, the timing t2 that control for increasing the potential at the first or second electrode from the state that the potential at the first or second electrode is lower potential of the first and second discharge maintaining potentials is started, the timing t3 that higher discharge maintaining potential of the first and second discharge maintaining potentials is applied to the first or second electrode, potential V(t1) at the first or second electrode at the timing t1, higher potential Vs of the first and second discharge maintaining potentials and the power supply voltage Va of the drive circuit for driving the third electrode satisfy the following relation:
Va>2(Vs−V(t1))
and
t1≠t3.

10. A drive circuit according to claim 9, wherein the timing t1 that the state of the third electrode is changed from the state that the third electrode is not connected to the fixed potential to the state that the third electrode is connected to the fixed potential, the timing t2 that the potential at the first or second electrode falls from the state that the potential at the first or second electrode is higher potential of the first and second discharge maintaining potentials and lower discharge maintaining potential of the first and second discharge maintaining potentials is applied to the first or second electrode, and the timing t3 that control for increasing the potential at the first or second electrode from the state that the potential at the first or second electrode is lower potential of the first and second discharge maintaining potentials is started satisfy the following relation:
t2≦t1<t3.

11. A plasma display apparatus which reuses electric charge withdrawn from pixels to make the pixels emit light, wherein
after the pixels are charged with the withdrawn electric charge at predetermined periods, the pixels are charged with new electric charge to be made to emit light and thereafter electric charge is withdrawn from the pixels, and
the pixels are set to non-high-impedance state during a period that the pixels are charged with the withdrawn electric charge,
the pixels being set to high-impedance state at least during the pixels are charged with the new electric charge.

12. A plasma display apparatus according to claim 11, comprising
a display panel including a plurality of pixels and
a drive circuit to charge the pixels with electric charge,
and wherein
the drive circuit charges the pixels with the withdrawn electric charge at predetermined periods and then charges the pixels with new electric charge to be made to emit light, so that electric charge is thereafter withdrawn from the pixels,
the drive circuit setting the pixels to non-high-impedance state during the period that the pixels are charged with the withdrawn electric charge,
the drive circuit setting the pixels to high-impedance state during the period that the pixels are charged with the new electric charge.

13. A plasma display apparatus according to Claim 12, wherein
the pixels are set to high-impedance state from first predetermined timing within a period after the second half of the period that the pixels are charged with the withdrawn electric charge and before the pixels are charged with the new electric charge until second predetermined timing within a period after the second half of the period that electric charge is withdrawn from the pixels and before the pixels are recharged with the withdrawn electric charge.

14. A plasma display apparatus according to claim 13, wherein
the first timing is further defined after charging of the pixels with the withdrawn electric charge is ended and
the second timing is further defined after the pixels are reset to predetermined potential after electric charge is withdrawn from the pixels.

15. A plasma display apparatus which reuses electric charge withdrawn from pixels to make the pixels emit light, comprising:
a display panel including a first electrode arranged on one side of the display panel and a second electrode disposed on the other side of the display panel to form the pixels between the first and second electrodes;
a first drive circuit to drive the first electrode using a power supply circuit; and
a second drive circuit to drive the second electrode using the power supply circuit;
the first drive circuit applying voltage to the first electrode using the power supply circuit to make the pixels emit light after voltage is applied to the first electrode using the withdrawn electric charge at predetermined periods and thereafter withdrawing electric charge from the pixels through the first electrode;
the second drive circuit connecting the second electrode to a fixed potential end during period that the first drive circuit applies voltage to the first electrode using the withdrawn electric charge and separating the second electrode from the fixed potential end at least during period that the first drive circuit applies voltage to the first electrode using the power supply circuit.

16. A plasma display apparatus according to claim 15, wherein
the fixed potential end is ground.

17. A plasma display apparatus according to claim 15, wherein
the second drive circuit separates the second electrode from the fixed potential end from a first predetermined timing within a period after the second half of the period that the first drive circuit applies voltage to the first electrode using the withdrawn electric charge and before the first drive circuit applies voltage to the first electrode using the power supply circuit until a second predetermined timing within a period after the second half of the period that the first drive circuit withdraws electric charge from the pixels and before the first drive circuit applies voltage to the first electrode again using the withdrawn electric charge.

18. A plasma display apparatus according to claim 17, wherein
the first timing is further defined after application of voltage by the first drive circuit to the first electrode using the withdrawn electric charge is ended and
the second timing is further defined after the first drive circuit resets the pixels to predetermined potential after the first drive circuit withdraws electric charge from the pixels.

19. A plasma display apparatus which reuses electric charge withdrawn from pixels to make the pixels emit light, comprising:
a display panel including first and second electrodes arranged on one side of the display panel and a third electrode disposed on the other side of the display panel, the pixels being formed between the first and third electrodes or between the second and third electrodes;
a first drive circuit to drive the first electrode using a power supply circuit; and
a second drive circuit to drive the second electrode using the power supply circuit;
the first or second drive circuit applying voltage to the first or second electrode using the power supply circuit to make the pixels emit light after voltage is applied to the first or second electrode using the withdrawn electric charge at predetermined periods and thereafter withdrawing electric charge from the pixels through the first or second electrode;
parasitic capacitance formed between the first and third electrodes being connected in series to parasitic capacitance formed between the second and third electrodes at least during a period that the first or second drive circuit applies voltage to the first or second electrode using the power supply circuit.

20. A plasma display apparatus according to claim 19, wherein
the parasitic capacitance formed between the first and third electrodes is connected in series to the parasitic capacitance formed between the second and third electrodes from a first predetermined timing within a period after the second half of the period that the first or second drive circuit applies voltage to the first or second electrode using the withdrawn electric charge and before the first or second drive circuit applies voltage to the first or second electrode using the power supply circuit until a second predetermined timing within a period after the second half of the period that the first or second drive circuit withdraws electric charge from the pixels and before the first or second drive circuit applies voltage to the first or second electrode again using the withdrawn electric charge.
